(19) United States
(12) Patent Application Publication
(10) Pub. No.: US 2002/0047110 A1
(43) Pub. Date: Apr. 25, 2002

(54) Flame synthesized aluminum nitride filler-powder

(75) Inventors: Yasumasa Takao, Aichi (JP); Mutsuo Sando, Aichi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Nat'l. Inst. of Adv. Industrial Science and Tech., Tokyo (JP)

(21) Appl. No.: 09/981,766

(22) Filed: Oct. 19, 2001

(30) Foreign Application Priority Data
Oct. 23, 2000 (JP) 2000-322130

(51) Int. Cl. H01B 1/00

(52) U.S. Cl. 252/500

(57) ABSTRACT

This invention provides a manufacturing method and manufacturing apparatus, in which a nitridation reaction is caused to proceed in a vapor phase in the presence of a flame, wherein the desired aluminum nitride powder is manufactured by simultaneously controlling the following technical conditions: that are (1) forming of a highly dispersed and stable fluidized or aerosol state of a raw-material powder whose particle size is included within the range of 0.001 to 500 μm, (2) adjusting of the gas atmosphere in the flame, and utilizing of a direct nitridation method or a reduction nitridation method in which the high temperature of the flame is used as a driving force, and (3) controlling of the quantitative ratio of the raw material and the flame, or combining of heat treatment processes to be continued.

### BACKGROUND OF THE INVENTION

1. Field of the Invention

The present invention relates to a novel aluminum nitride powder, and a manufacturing method and manufacturing apparatus for the same. More particularly, the present invention relates to a novel aluminum nitride powder, and a manufacturing method and manufacturing apparatus for the same, wherein the particle size and degree of spherical shape required in the raw-material powder (filler), which is used in a composite system in which a powder composed of inorganic materials is to be filled in a resin type raw material composed of organic materials, are achieved by a nitridation reaction thereof being proceeded in a vapor phase in the presence of a flame.

2. Description of the Related Art

In techniques relating to electronic materials, composite material systems in which a powder composed of inorganic materials is filled in a resin type raw material composed of organic materials are important material systems that are used as insulating materials, electrode and conductor materials, electrical viscous fluids, chemical-mechanical polishing slurries and ceramic molding process raw materials for injection molding and cast molding or the like. In recent years, furthermore, such composite material systems have come to be widely used in packaging materials used for the protection or insulation of semiconductor elements. In order to handle the reduction in the size of elements that has accompanied the development of VLSI, packaging materials used to realize the formation of arbitrary shapes and injection between very small electrodes must have low viscosity and high moldability along with high heat dissipation, high thermal conductivity and lower thermal expansion characteristics.

Currently, amorphous spherical silica powders consisting of the elements Si and O constitute the mainstream of inorganic filler powders to be used as fillers for the purpose of improving heat dissipation and other characteristics. From the standpoint of thermal characteristics, it is desirable to use large amounts of silica as a filler. In such cases, however, the viscosity and moldability drop, and as a result, there are limits to the amount of silica that can be used. Accordingly, the particle size distribution and surface modification of silica have been investigated, and the addition of micro-particles or the like has been attempted, with the aim of allowing the addition of large amounts of silica without damaging the moldability, and processes in which these various types of controls are combined have been employed. However, it has been pointed out that in the case of current filler characteristics, there are limits to the ability to meet the accelerating requirements for precision that will be necessary in the planned next generation of semiconductor elements and the like (for example, see Shinsuke Hagiwara, “Conditions of Development of Semiconductor Sealing Materials”, Plastics, Vol. 49, p. 58, 1998).

While the theoretical thermal conductivity of silica is approximately 2 Wm⁻¹ K⁻¹, that of aluminum nitride is approximately 300 Wm⁻¹ K⁻¹, so that a high degree of heat dissipation may be expected even in cases where the amount of aluminum nitride added is less than the amount of silica added. Specifically, if an aluminum nitride filler is present whose characteristics other than thermal characteristics, such as particle size distribution, degree of spherical shape and the like, are comparable to the characteristics of current silica fillers, there is a possibility that the thermal characteristics, viscosity and moldability can be simultaneously improved to an unprecedented extent. From this standpoint, attempts to replace “some part” of silica with an aluminum nitride powder have been published (for example, see Japanese Patent Application Laid-Open No. 9-183610/1997). At the current point in time, however, aluminum nitride powders which have the particle size (several microns to several tens of microns) required in a filler powder are manufactured mainly by the direct nitridation process, in which manufacture is accomplished by a pulverization process. Accordingly, such powders are non-spherical powders which have angular shapes, and therefore suffer from the drawback of a conspicuously lowered viscosity and moldability. Accordingly, the simultaneous addition of a spherical silica powder is considered necessary, and the only method of use that has been possible is a method in which only a portion of the silica is replaced.

The reduction nitridation method in which a mixture of alumina and carbon is sintered in a nitrogen atmosphere also exists as an industrial manufacturing method alongside the direct nitridation method. In the case of the reduction nitridation method, in which no pulverization process is necessary, a powder with a relatively high degree of spherical shape can be manufactured. However, current reduction nitridation processes have been established mainly as processes for supplying the raw-material powders of sinters. Accordingly, such processes deal mainly with powders whose mean particle size is on the sub-micron order, and have not been devised so that powders that have a particle size on the order of ten-odd microns or greater, which are mainly required as filler powders, can easily be used. Furthermore, in the case of the reduction nitridation method which involves an endothermic reaction that is the exact opposite of the exothermic direct nitridation method, a heat treatment for a fixed time or longer in the high-temperature region of approximately 1500 to 1800° C. is essential, and in cases where a raw-material powder of alumina or the like with a large particle size is prepared in order to manufacture a powder with a relatively large particle size such as a filler powder, it has not been confirmed that a reduction nitridation process can be proceeded efficiently by using an electric furnace alone.

Aluminum nitride powder manufacturing methods that have been investigated at the laboratory level include the vapor phase (aerosol) synthesis method, the flame CVD method, the hot plasma method and others, using an organic precursor as a raw material. However, in the abovementioned methods, the raw material is first placed in completely gaseous state, after which nucleus formation and particle growth processes are performed. Accordingly, cases in which the primary particle size of the product ranges from several nanometers to several tens of nanometers may be viewed as the majority of cases, and products with a mean particle size range of 0.1 to 100 μm (required in an inorganic filler powder) such as the powder of the present invention cannot be realized.

Specifically, in the cases of the three main existing methods for manufacturing aluminum nitride powders, there are the following problems, that are (1) the particle size is satisfactory but the desired shape cannot be obtained in the case of the direct nitridation method, (2) the degree of spherical shape is satisfactory but the desired particle size cannot be obtained in the case of the reduction nitridation method, and (3) the desired particle size cannot be obtained in the case of conventional vapor phase synthesis methods, which indicate that, at the current point in time, it is impossible to satisfy both particle size and shape requirements.

In the case of the silica used in current typical fillers, a chemical flame process is generally used in which a silica raw material or powdered metallic Si is placed in the combustion flame of a mixed gas consisting of a combustible gas and oxygen, and silica particles with a highly spherical shape are manufactured melting of the raw material surface or an evaporation-reaction-crystallization process in the vapor phase. In cases where a chemical reaction proceeds in a vapor phase, there is little exertion of an effect from the periphery in three-dimensional terms, and accordingly, the relative ease with which a spherical shape can be formed by aerosol synthesis, which is a characteristic feature of this method, is utilized. If this method and manufacturing apparatus are applied to an aluminum nitride powder, numerous advantages may be expected, that are (1) the drawbacks of small particle size or large shape anisotropy can be eliminated, (2) the controllability of powder characteristics such as particle size distribution and the like can be improved, and the investigation time required in order to obtain the necessary characteristics can be shortened, by utilizing intellectual property and know-how relating to powder synthesis control and the like that have been accumulated in the field of silica filler synthesis, and (3) an advantage in terms of initial investment in equipment can be obtained by utilizing a manufacturing apparatus that uses the chemical flame method. In the past, however, an “aluminum nitride ‘filler’ chemical flame process” has not been realized (although it appears that such a process has been investigated). In this regard, the following problems have been encountered, that are (1) in the case of aluminum nitride, which unlike silica has no melting point, the formation of a spherical shape by “melting of the surfaces of the raw-material powder” cannot be expected, (2) non-oxide aluminum nitride cannot be manufactured merely by placing the raw material in a flame in which “oxygen” is present, and (3) in the past, it has been considered necessary to synthesize a powder that has a complete aluminum nitride crystalline structure in a single reaction, so that no attention has been paid to the possibility of combining a plurality of reactions into a single continuous reaction, which is a characteristic feature of vapor-phase synthesis.

### SUMMARY OF THE INVENTION

The present invention alleviates the drawbacks of conventional aluminum nitride powders and manufacturing methods and manufacturing apparatuses for the same, and provides a novel aluminum nitride powder, as well as a manufacturing method and manufacturing apparatus for the same, wherein the particle size of several microns to several tens of microns and the degree of spherical shape required in the raw-material powder (filler), which is used in a composite system in which a powder composed of inorganic materials is to be filled in a resin type raw material composed of organic materials, are simultaneously achieved.

An object of the present invention is to overcome the drawbacks of such conventional aluminum nitride powders and aluminum nitride powder manufacturing methods and manufacturing apparatuses, and to provide a novel aluminum nitride powder, and a manufacturing method and manufacturing apparatus for the same, wherein the particle size and degree of spherical shape required in the raw-material powder (filler), which is used in a composite system in which a powder composed of inorganic materials is to be filled in a resin type raw material composed of organic materials, are achieved by a nitridation reaction thereof being proceeded in a vapor phase in the presence of a flame.

The present inventors noted the following points: (1) First, in cases where a chemical reaction proceeds in a vapor phase, even if a melting process cannot be utilized as in the case of silica, there is little exertion of an effect from the periphery in three-dimensional terms; accordingly, the relative ease with which a spherical shape can be formed by aerosol synthesis, which is a characteristic feature of this method, can be utilized, (2) Secondly, carbide particles and diamond thin films are manufactured by means of a reducing combustion flame in which the proportions of a combustible gas and oxygen are adjusted so that the amount of oxygen is less than the amount of oxygen in the perfect combustion ratio, and (3) In a chemical flame process, the combination of a plurality of reactions into a continuous process, which is a characteristic feature of vapor-phase synthesis, is possible (or is relatively easy).

In concrete terms, as a result of diligent research that was conducted for the purpose of realizing the above-mentioned concept, the inventors discovered that an aluminum nitride powder that achieves the particle size and degree of spherical shape required in a filler can be manufactured by simultaneously and effectively combining the control of the following three points: (1) The powder-form raw material is supplied in a highly disperse state in which there is little aggregation by utilizing a fluidized bed process which combines the use of a fluidized catalyst, (2) From the standpoints of productivity and adjustment of the oxygen concentration in a combustion flame or plasma flame, a direct nitridation process or reduction nitridation process is used as, the main reaction system, and (3) The productivity of the crystalline structure of aluminum nitride is increased by optimizing the quantitative ratio of the raw material and flame, or an intermediate-phase precursor consisting of the elements Al, O and N is first manufactured, and this is converted into the crystalline structure of aluminum nitride by performing a continuous heat treatment process in a later stage. The present invention was perfected on the basis of such findings.

Specifically, the present invention provides a novel aluminum nitride powder which achieves a particle size of several microns to several tens of microns and a degree of spherical shape that could only be imagined in the past, as well as a manufacturing method and manufacturing apparatus for this powder, by a nitridation reaction thereof being proceeded in a vapor phase in the presence of a flame.

In the present invention, the following constructions are adopted in order to solve the abovementioned problems:

(1) A flame synthesized aluminum nitride filler-powder containing the elements Al, O and N, or containing the elements Al and N, wherein the particle size of the powder is included within the range of 0.001 to 500 μm, the mean particle size thereof is within the range of 0.1 to 100 μm, the external shape of the particles is spherical, and the powder is manufactured in a vapor phase in the presence of a flame.

(2) The powder described in (1) above, wherein the powder is manufactured in the presence of the combustion flame of a single combustible gas consisting of the elements C or H, the combustion flame of a mixed gas consisting of a combustible gas and oxygen, a reducing combustion flame in which the proportions of a combustible gas and oxygen are adjusted so that the amount of oxygen is less than the amount of oxygen in the perfect combustion ratio, a flame created by the plasma of an inert gas, or an arc flame generated between metals in a non-contact state to which a high voltage is applied.

(3) The powder described in (1) above, wherein the raw material is a powder consisting of the element Al whose particle size is included within the range of 0.01 to 500 μm, and a nitridation reaction is caused to proceed by using a flame in the presence of nitrogen, ammonia or an inert gas.

(4) The powder described in (1) above, wherein the raw material is a mixture of a powder consisting of the elements Al and O and a powder consisting of the element C whose respective particle sizes are included within the range of 0.001 to 500 μm, and a nitridation reaction is caused to proceed by using a flame in the presence of nitrogen, ammonia or an inert gas.

(5) The powder prepared by the step of, subjecting the powder described in any of (1) through (4) above to a heat treatment either continuously or intermittently in a temperature range of 500 to 10,000° C. in the presence of air, nitrogen, ammonia or an inert gas, or in a vacuum state, by using a flame or an apparatus that is capable of applying a high temperature to the powder.

(6) A method for manufacturing the powder described in any of (1) through (5), containing the elements Al, O and N or containing the elements Al and N, comprising the steps of forming a raw-material powder whose particle size is included within the range of 0.001 to 500 μm, and whose mean particle size is within the range of 0.1 to 100 μm, into a highly dispersed and stable fluidized state or aerosol state, subjecting the raw-material powder to a nitridation reaction in which direct nitridation or reduction nitridation is performed in the presence of a flame, so that a nitride is synthesized, and if necessary heat-treating the nitride.

(7) A raw-material powder (filler) consisting of the powder described in any of (1) through (5) above containing the elements Al, O and N, or a powder containing the elements Al and N, characterized in that the powder is used as a raw-material powder (filler) in a composite material system in which a powder composed of inorganic materials is to be filled in a resin type raw material composed of organic materials.

(8) An apparatus which is used to manufacture the powder described in any of (1) through (5) above, comprising a flame generating device, a raw-material powder supply device and a device which supplies air, nitrogen, ammonia or an inert gas as the constituent elements of the apparatus, wherein a nitridation reaction of the raw-material powder is proceeded in a vapor phase in the presence of a flame.

(9) The manufacturing apparatus described in (8) above, comprising a flame generating apparatus with a structure in which a plurality of cylindrical tubes having different internal diameters are combined in a coaxial configuration as a constituent element of the apparatus, wherein the raw-material powder is supplied to one of the cylindrical tubes, a reaction gas is supplied to other cylindrical tubes, the raw-material powder and the reaction gas are diffused and mixed in the vicinity of the tip end portion of the said cylindrical tube containing the raw-material powder, and a nitridation reaction of the raw-material powder is proceeded in a vapor phase in the presence of a flame.

### BRIEF DESCRIPTION OF THE DRAWINGS

FIG. 1 is a model diagram of one example of the construction of a manufacturing apparatus based on the present invention; and

FIG. 2 is SEM photographs of one example of an aluminum nitride powder manufactured in the present embodiment.

### DESCRIPTION OF THE PREFERRED EMBODIMENTS

Next, the present invention will be described in even greater detail.

Important technical conditions of the present invention are found in the following three points: (1) The formation of a highly dispersed and stable fluidized or aerosol state of a raw-material powder whose particle size is included within the range of 0.001 to 500 μm, (2) adjustment of the gas atmosphere in the flame, and utilization of a direct nitridation method or reduction nitridation method in which the high temperature of the flame is used as a driving force, and (3) control of the quantitative ratio of the raw material and the flame, or the combination of heat treatment processes into a continuous process.

In regard to the material system of the powder-form raw material described as “a powder consisting of the element Al”, metallic aluminum powders with an arbitrary particle size or vapor-phase-synthesized Al type powders with a highly spherical shape which are manufactured by a water, gas or centrifugal atomizing methods are considered ideal. Further, low-boiling-point vapor-phase-synthesized raw materials, e.g., chlorides such as AlCl₃ or the like, alkoxide raw materials such as aluminum isopropoxide (Al(iso-OC₃H₅)₃) or the like, β-diketone complexes such as aluminum acetylacetonate (Al(iso-C₅H₇O₂)₃) or the like, and alkylmetals such as trimethylaluminum (Al(CH₃)₃) or the like, may also be cited as examples, and there are no particular restrictions on the compounds used.

In regard to the material system of the powder-form raw material described as “a mixture of a powder consisting of the elements Al and O and a powder consisting of the element C”, first of all, regarding the “powder consisting of the elements Al and O”, alumina (Al₂O₃) powders manufactured by the commercial Bayer method, the modified Bayer method, the alkoxide method, the ammonium dawsonite method, the vapor-phase method or the like are considered ideal. However, low-boiling-point vapor-phase-synthesized raw materials, e.g., multiple systems (intermediate alumina systems) of α-, γ-, θ- or κ-Al₂O₃, hydroxide precursors expressed by the chemical formulae AlOOH and Al(OH)₃, carbonate precursors expressed by the chemical formulae of an acetylacetonate (Al(C₅H₇O₂)₃) or ammonium dawsonite (NH₄AlCO₃ (OH)₂), alkoxide raw materials such as aluminum isopropoxide (Al(iso-OC₃H₅)₃) or the like, β-diketone complexes such as aluminum acetylacetonate (Al(iso-C₅H₇O₂)₃) or the like, and alkylmetals such as trimethylaluminum (Al(CH₃)₃) or the like, may also be cited as examples, and there are no particular restrictions on the powder used.

Furthermore, in regard to the “powder consisting of the element C”, high-purity vapor-phase-synthesized carbon powders of any desired particle size such as powdered carbon, carbon black, acetylene black or the like may be cited as examples, and there are no particular restrictions on the powder used.

In the abovementioned raw-material powders, a particle size included within the range of 0.001 μm to 500 μm and a mean particle size within the range of 0.1 to 100 μm are set as technical conditions; the reason for this is that the shape of the raw-material powder is reflected in the shape of the aluminum nitride powder that is synthesized.

Furthermore, examples of apparatuses that can be used as the supply apparatus of the raw-material powder include screw type supply apparatuses such as kneaders or the like, rotor type supply apparatuses such as two-shaft mills or the like, and gas supply apparatuses used to convey powders.

In regard to the method used to form a fluidized or aerosol state of the raw-material powder, various types of fluidized bed methods in which the powder is caused to reside in a gas current (including medium fluidized bed methods in which a high degree of dispersion is obtained while preventing aggregation of the raw-material powder by simultaneously using a medium with a diameter of several hundred microns which is larger than the raw-material powder and easily fluidized, and vibrating fluidized bed methods in which the channeling of very fine particles is prevented by applying a vibration to the powder bed) are considered to be ideal; however, for example, various types of spray methods in which the powder is carried in a gas current suing a rotary disk or gas nozzle, and liquid spray methods in which the powder is dispersed in a liquid medium and converted into liquid droplets together with the liquid by means of an ultrasonic spray device, centrifugal spray device or the like, may also be used. Thus, there are no particular restrictions on the method used, and a fluidized raw-material powder prepared by any desired method may be used.

Examples of devices that can be used to supply and control the air, nitrogen, ammonia or inert gas that is used include compressed gas supply devices such as compressors or the like, as well as utilization of the internal pressure of a high-pressure gas cylinder supplied from gas manufacturing equipment, and floating ball type flow meters, mass flow controllers and the like.

In regard to the raw material of the flame and method used to generate the flame, various types of combustible gases consisting of the elements C or H and the like such as hydrogen (H₂), liquefied petroleum gases such as methane (CH₄), butane (C₃H₈) and acetylene (C₂H₂) or the like, or ammonia (NH₃), and a combustion-supporting gas such as oxygen (O₂) or the like, are considered to be ideal. However, it would also be possible to use a plasma flame created by the electrolytic dissociation of an inert gas such as argon (Ar) or the like, or an arc flame generated between metals in a non-contact state to which a high voltage is applied, such as a covered rod arc, submerged arc, inert gas arc or the like. Thus, there are no particular restrictions on the flame generation method, and flames created by any desired method may be used.

Examples of flame generating apparatuses that can be used include gas burners using liquefied gas or municipal gas, gas welding guns, arc welding guns and hot plasma devices or the like. Ideally, for example, an apparatus in which a flame generating device with a structure in which a plurality of cylindrical tubes having different internal diameters are combined in a coaxial configuration is provided as a constituent element of the apparatus, the raw-material powder is supplied to certain of the cylindrical tubes, a reaction gas is supplied to other cylindrical tubes, the raw-material powder and the reaction gas are diffused and mixed in the vicinity of the tip end portions of the cylindrical tubes containing the raw-material powder, and a nitridation reaction of the raw-material powder is caused to proceed in a vapor phase in the presence of a flame, may be cited as an example.

In regard to the method and apparatus used to apply a high temperature either continuously or intermittently to the powder synthesized in a flame, an ordinary electric furnace used in a thermal CVD process or the like is considered to be ideal. However, flame re-heating accomplished by providing a plurality of combustion flames used for heat treatment, the utilization of a plasma flame or arc flame, and the use of image furnace type heating or the like, are also possible, and there are no particular restrictions on the method or apparatus used.

The conditions of the heat treatment are determined by the configuration and crystal phase of the as-prepared powder immediately following synthesis in a flame. In cases where the conditions are satisfied by the characteristics of the as-prepared powder, a heat treatment is not always necessary. A gas flow rate range of 0.001 to 1000 L/min for nitrogen, ammonia or an inert gas, and a temperature range of 500 to 1000° C., may be cited as examples of general conditions. As a result of this heat treatment, an exceptional effect of high controllability of the proportions of the Al—O—N intermediate and the AlN phase is obtained.

In regard to the composite material system in which a powder composed of inorganic materials is used to fill a resin type raw material composed of organic materials, a packaging material used for the protection, insulation or the like of semiconductor elements is considered to be ideal. However, other material systems, e.g., insulating materials, electrode and conductor materials, electrical viscous fluids, chemical-mechanical polishing slurries and ceramic molding process raw materials for injection molding and cast molding or the like may also be cited as examples. In regard to the powder-form raw material consisting of an inorganic material that constitutes a filler, silica (SiO₂) and aluminum nitride (AlN) which are widely used as semiconductor packaging materials are considered to be ideal; however, other oxide systems such as Al₂O₃, SiC and Si₃N₄ or the like, and metal systems such as Au, Ag, Pd, Pt, Cu, Al and Au—Pd or the like, can also naturally be used, and there are no particular restrictions on the material used. Furthermore, there are likewise no restrictions on the crystallinity of the material used; either crystalline or amorphous materials may be used. In regard to the liquid-form material used as a medium, in addition to aqueous systems such as ion exchange water, distilled water or the like, and organic non-aqueous systems such as ethanol or the like, resin materials that are solids at ordinary temperatures, e.g., resol type or novolak type phenol resins, bisphenol type cresol novolak polyfunctional epoxy resins, and halogenated resins or the like, and resin materials which are liquids at ordinary temperatures and which are widely used as packaging materials for the next generation of semiconductor elements, are considered to be ideal; however, there are no particular restrictions on the material used as a medium.

The present invention makes it possible to provide an aluminum nitride powder in which a mean particle size on the order of 10 microns, a broad particle size distribution ranging from the sub-micron order to the order of ten-odd microns, and a high spherical shape, are simultaneously obtained; the present invention also makes it possible to provide a manufacturing technique and a manufacturing apparatus for such an aluminum nitride powder. In particular, such a powder is optimal as the raw-material filler powder in a composite material system in which a powder composed of inorganic materials is used to fill a resin type raw material composed of organic materials, with a semiconductor packaging material considered ideal.

The characteristics of the aluminum nitride powder synthesized by the method of the present invention are shown below.

The particle size range is included within the values of 0.001 to 500 μm, the mean particle size range is 0.1 to 100 μm, and the external shape of the particles is spherical with the ratio of the long-axis diameter to the short-axis diameter being more or less 1:1. Furthermore, the powder can be manufactured with the crystal phase being arbitrarily controlled from an Al—O—N intermediate phase to an AlN phase.

### EXAMPLE

Next, the present invention will be concretely described in terms of a working example. However, the present invention is not limited in any way by the following working example.

(1) Method

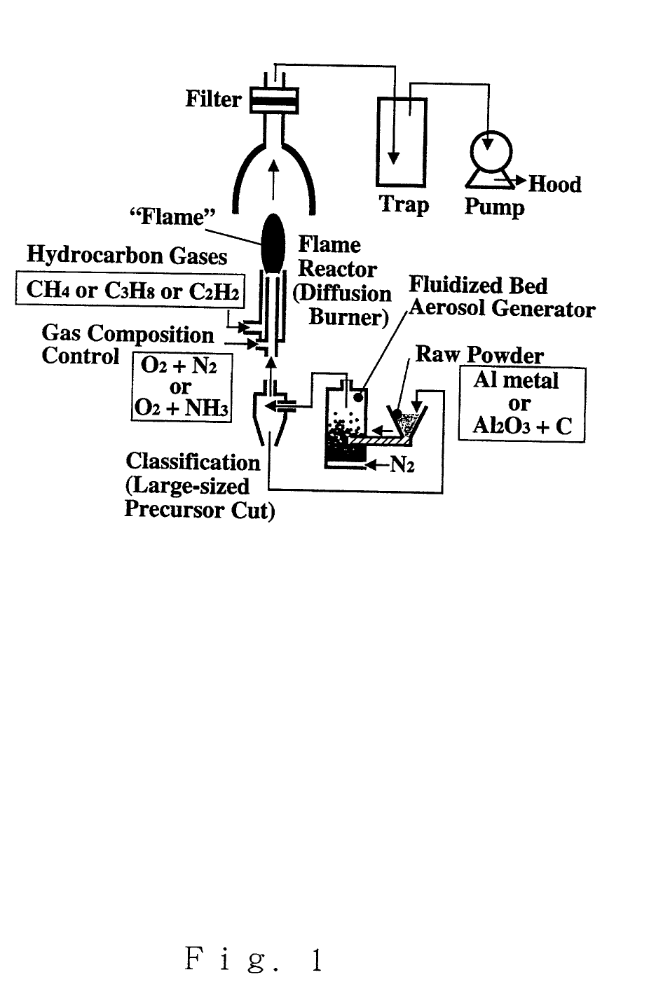

FIG. 1 shows one example of the construction of a manufacturing apparatus based on the present invention in model form. An aerosol synthesis process consisting of a chemical flame of the liquefied petroleum gas and oxygen/nitrogen/ammonia type, and a powder-form raw-material powder was used as the basis of this example. In FIG. 1, a constitution comprising the steps of supplying an Al metal or Al₂O₃+C raw-material powder (raw powder) and nitrogen gas to a fluidized bed aerosol generator, classifying the aerosol particle sizes, supplying hydrocarbon gases to a flame reactor (diffusion burner), supplying oxygen and nitrogen as gas composition control factors, performing vapor-phase synthesis with a flame, and applying suction to the product by means of a pump so that the product is passed through a filter and trapped. As an example of a basic reaction system using the chemical flame method, the direct nitridation of an Al powder was used (reduction nitridation could also be used). The Al raw-material powder used was a spherical powder with a diameter of 10 μm produced by the gas atomization method. The fluidization method used was the medium fluidized bed method; glass beads with diameter of 150 μm were used as the medium. The reaction vessel used was a diffuse flame type reaction vessel consisting of a double cylindrical tube made of stainless steel; the raw-material powder and reaction gas were supplied to the innermost tube, while the flame raw-material gas was supplied to the outermost tube. The raw-material powder was supplied by means of nitrogen gas at the rate of 10 L/min, the liquefied petroleum gas was supplied at the rate of 5 L/min, and the oxygen gas constituting the control factor was adjusted to the reducing flame side from the stoichiometric ratio with the liquefied petroleum gas. Furthermore, if necessary, the synthesized powder was heat-treated at approximately 1000° C. in a 0.5 L/min current of nitrogen gas.

(2) Results

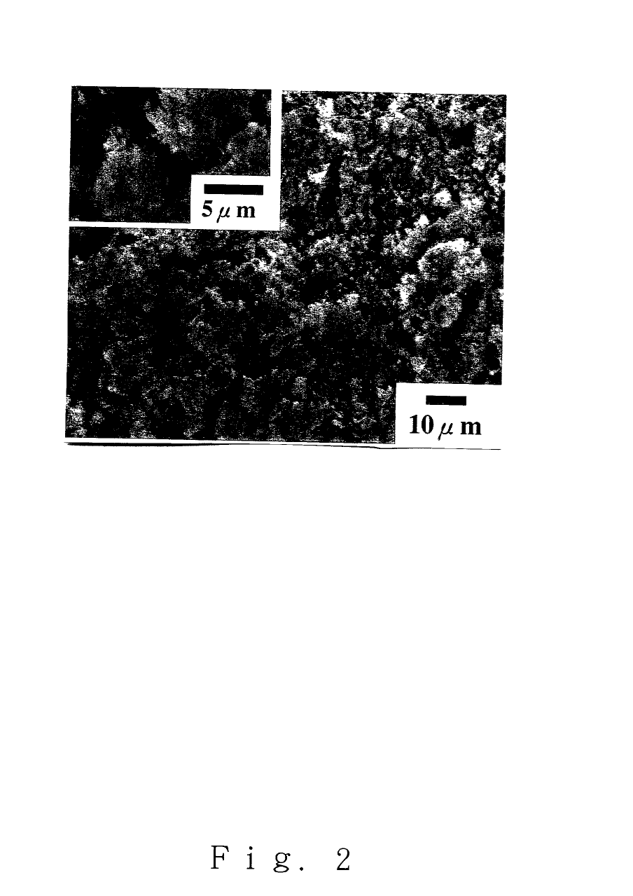

FIG. 2 shows SEM photographs of one example of an aluminum nitride powder produced by the method of the present invention. Here, (1) a mean particle size on the order of approximately 10 microns, (2) a broad particle size distribution ranging from the sub-micron order to the order of ten-odd microns, and (3) a highly spherical shape, which are the main requirements in a filler powder, are realized, and a novel aluminum nitride powder in which a particle size (and “particle size distribution”) and degree of spherical shape that could only be imagined in the past are simultaneously achieved can be obtained.

In the present invention, as was described above, the following exceptional effects are obtained, that are (1) an aluminum nitride powder which has a mean particle size on the order of 10 microns is obtained, (2) an aluminum nitride powder with a broad particle size distribution ranging from the sub-micron order to the order of 10-odd microns is obtained, (3) the abovementioned particle size conditions are satisfied, and a high spherical shape not obtainable in the past is simultaneously realized (conventionally, in the case of aluminum nitride powders with a mean particle size of approximately 10 microns, only powders with a high angular shape anisotropy have been obtainable), and (4) in particular, the powder of the present invention is optimal for use as the raw-material powder in a composite material system in which a powder composed of inorganic materials is to be filled in a resin type raw material composed of organic materials, wherein a semiconductor packaging material is considered ideal.

What is claimed is:

1. A flame synthesized aluminum nitride filler-powder containing elements Al, O and N, or containing elements Al and N, characterized in that the particle size of the powder is included within the range of 0.001 to 500 μm, the mean particle size thereof is within the range of 0.1 to 100 μm, the external shape of the particles is spherical, and the powder is manufactured in a vapor phase in the presence of a flame.

2. The powder according to claim 1, wherein said powder is manufactured in the presence of a combustion flame of a single combustible gas consisting of elements C or H, a combustion flame of a mixed gas consisting of a combustible gas and oxygen, a reducing combustion flame in which the proportions of the combustible gas and oxygen are adjusted so that the amount of oxygen is less than the amount of oxygen in the perfect combustion ratio, a flame created by the plasma of an inert gas, or an arc flame generated between metals in a non-contact state to which a high voltage is applied.

3. The powder according to claim 1, wherein the raw material is a powder consisting of element Al whose particle size is included within the range of 0.01 to 500 μm, and a nitridation reaction is proceeded by using a flame in the presence of nitrogen, ammonia or an inert gas.

4. The powder according to claim 1, wherein the raw material is a mixture of a powder consisting of elements Al and O and a powder consisting of element C whose respective particle sizes are included within the range of 0.001 to 500 μm, and a nitridation reaction is proceeded by using a flame in the presence of nitrogen, ammonia or an inert gas.

5. The powder prepared by the step of, subjecting the powder defined in any of claims 1 through 4 to a heat treatment either continuously or intermittently in the temperature range of 500 to 10,000° C. in the presence of air, nitrogen, ammonia or an inert gas, or in a vacuum state, by using a flame or an apparatus that is capable of applying a high temperature to the powder.

6. A method for manufacturing the powder defined in any of claims 1 through 5, containing elements Al, O and N or containing elements Al and N, said comprising the steps of:
forming a raw-material powder whose particle size is included within the range of 0.001 to 500 μm, and whose mean particle size is within the range of 0.1 to 100 μm, into a highly dispersed and stable fluidized state or aerosol state;
subjecting said raw-material powder to a nitridation reaction in which direct nitridation or reduction nitridation is performed in the presence of a flame, so that a nitride is synthesized; and if necessary heat-treating said nitride.

7. A raw-material powder (filler) consisting of the powder defined in any of claims 1 through 5 containing elements Al, O and N or a powder containing elements Al and N, characterized in that the powder is used as a raw-material powder (filler) in a composite material system in which a powder composed of inorganic materials is to be filled in a resin type raw material composed of organic materials.

8. An apparatus which is used to manufacture the powder defined in any of claims 1 through 5, comprising a flame generating device, a raw-material powder supply device and a device which supplies air, nitrogen, ammonia or an inert gas as the constituent elements of the apparatus, wherein a nitridation reaction of the raw-material powder is proceeded in a vapor phase in the presence of a flame.

9. The manufacturing apparatus according to claim 8, containing a flame generating device with a structure in which a plurality of cylindrical tubes having different internal diameters are combined in a coaxial configuration as a constituent element of the apparatus, wherein the raw-material powder is supplied to any of the cylindrical tubes, a reaction gas is supplied to other cylindrical tubes, the raw-material powder and the reaction gas are diffused and mixed in the vicinity of the tip end portions of the cylindrical tubes containing the raw-material powder, and a nitridation reaction of the raw-material powder is proceeded in a vapor phase in the presence of a flame.
